(19) United States
(12) Patent Application Publication
(10) Pub. No.: US 2005/0015477 A1
(43) Pub. Date: Jan. 20, 2005

(54) Server management method and system

(76) Inventor: Chih-Wei Chen, Taipei (TW)

Correspondence Address: BIRCH STEWART KOLASCH & BIRCH, PO BOX 747, FALLS CHURCH, VA, 22040-0747, US

(21) Appl. No.: 10/714,886

(22) Filed: Nov. 18, 2003

(30) Foreign Application Priority Data
May 26, 2003 (TW) 092114110

(51) Int. Cl. G06F 15/173

(52) U.S. Cl. 709/223

(57) ABSTRACT

A server management method and system is disclosed for allowing a user to control scheduling of a server via a remote terminal device. A management program module is installed in the server to receive and execute management commands. The management program module transmits a management command to an operating and/or control mechanism of the server according to management information sent by the user from the remote terminal device and through a network communication system. Thereby, the operating and/or control mechanism can control and manage the server according to the received management command. By the above server management process and system, the user can remotely manage and use the server, thereby increasing operating efficiency.

### FIELD OF THE INVENTION

The present invention relates to server management methods and systems, and more particularly to a server management method and system that can be remotely controlled by a user via a remote terminal device over a network.

### BACKGROUND OF THE INVENTION

As the demand and supply for business information service rapidly increases, a considerable amount of operational capital has been invested in the development of related hardware and software in order to manage the massive data transmission between companies or between companies and end users. Typically, the hardware used in the information management includes a network server, an e-mail server, an application program server, a file server, or a storage server; software used in information management includes various applications for the server, such as common programs, service programs, browsers, and other applications that are installed according to user's requirements.

In information management, network stability, safety of commercial data transmission and data storage, bandwidth, and data transmission performance are critical to information communication. Therefore, most companies employ technicians specialized in information management to set up and maintain a complete information communication system. Without provision or in the absence of said manpower responsible for the information management, serious breakdowns of the whole system caused by minor errors are inevitable.

In view of the above, it is apparent that information management plays an important role in the operation of a company, such that considerable manpower and material resources have been invested in the establishment and maintenance of information/network management. Taking for example the servers mentioned above, the storage server is a data storage device for network users to access data through a LAN. A disk server provides similar functions to that of a storage server, while further providing file management functions. Furthermore, data transmission sequences and orders can be altered by network users for protection purposes. Upon receiving numerous requests from various network users for data transmission at the same time, the file server or the storage server has to perform and process multiple tasks, resulting in a heavy workload.

In addition to the above-mentioned servers, other servers having different functions are also indispensable to overall network operation. Therefore, there is a constant demand for greater efficiency in server management. For example, the file server or storage server as described above is designed to provide long-time, highly efficient and centralized management services. A breach or breakdown of server service due to system maintenance can seriously impede the business operation of a company. It is often difficult to set an appropriate schedule for performing the system maintenance that is required and most suitable for all parties concerned. Should the system maintenance be preformed during peak time having high usage loads, this would inevitably causes great inconvenience for users. And yet it is rather bothersome and untimely in terms of human scheduling if the system maintenance is performed during off-time when the usage load is low, for example, at night or during public holidays.

In consideration of the situation, an un-interruptible power supply (UPS) is usually provided for server management to protect the system from sudden interruption of power without notice. Even so, there are still unforeseeable risks and immeasurable damage that may cause to the system due to unexpected power cutoff. Therefore, there is an urgent need to come up with an improved server management system with higher efficiency, which allows the servers to be programmed and set to safely terminate operations before a power failure takes place, thereby avoiding the problems caused by unexpected power interruption, without having to depend on the physical presence of information management personnel standing by for such an emergency.

### SUMMARY OF THE INVENTION

It is therefore an objective of the invention to provide a server management method and system, which is capable of facilitating efficient server management through a server scheduling mechanism.

It is another objective of the invention to provide a server management method and system, which allows server management to be accomplished via a remote terminal device.

In order to achieve the above and other objectives, the present invention proposes a server management system for allowing a user to remotely manage a server via a remote terminal device and through a network communication system. The server management system includes a management program module mounted in the server, to receive management information sent by the user from the remote terminal device and through the network communication system, and to transmit a management command corresponding to the management information to an operating and/or control mechanism of the server where the management command is executed; an alarm unit for setting actuation time of a peripheral device of the server according to the management command; and a control unit for controlling in real time actuation of the peripheral device of the server according to the actuation time.

A server management method in the use of the server management system according to the invention includes the following steps. First, the management program module transmits a management command, which corresponds to the management information sent by the user from the remote terminal device and through the network communication system, to an operating system or the alarm unit of the server. Next, the operating system or the alarm unit adds a server control command to its operational schedule according to the management command. Finally, the operating system or the alarm unit drives the control unit to control the server according to the operational schedule.

Compared with the conventional server management techniques, the server management process and system of the present invention is capable of providing higher server management efficiency by means of a server scheduling mechanism through a remote terminal device.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram illustrating the application architecture of a server management system according to one embodiment of the invention;

FIG. 2 is a flow chart illustrating the process steps of a server management method according to one embodiment of the invention; and

FIG. 3 is a flow chart illustrating the process steps of a server management method according to another embodiment of the invention.

### DETAILED DESCRIPTION OF THE PREFERRED EMBODIMENTS

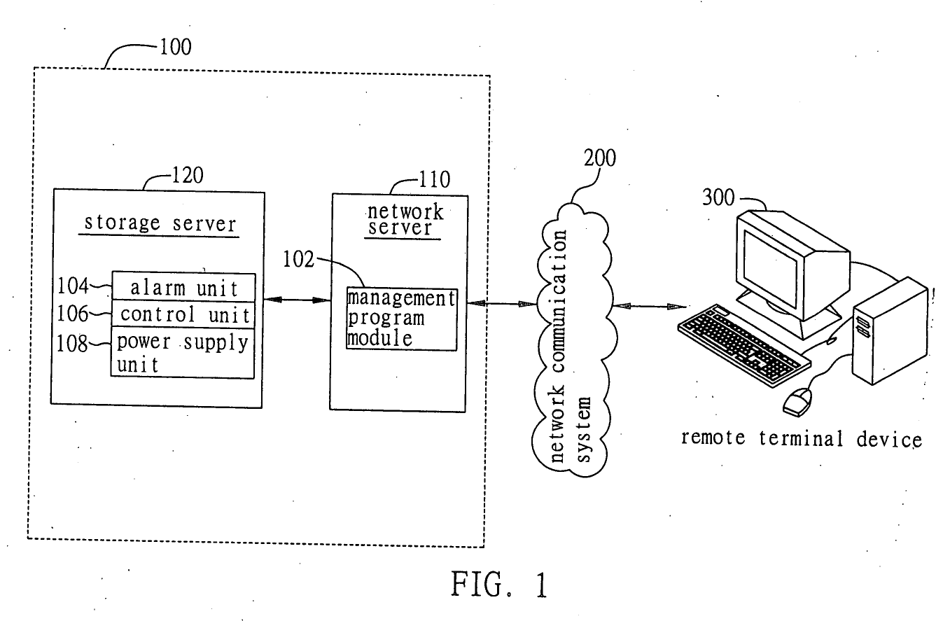

As illustrated in FIG. 1, a server management system 100 of the invention is used in a client-server network communication system 200. The server management system 100 includes at least a network server 110 and a storage device. Through the network server 110, the network communication system 200 is connected to a remote terminal device 300. The network server 110 further provides a responding function to allow the remote terminal device 300 to perform data access according to user's commands and requirements. The storage device enables network users to access files stored therein. The server management system 100 includes a storage server 120 which allows users to transmit files in sequential order and alter data transmission sequences of the files upon users' requests.

The above server management system 100, having the network server 110 and the storage server 120, provides services to a client-end of the remote terminal device 300, wherein a browser application may be used to connect the client-end of the remote terminal device 300 via the network communication system 200 to the network server 110 at the server-end of the server management system 100, in order to accomplish uploading or downloading of desired programs or data, including server management information, and perform data storage/management. The network communication system 200 can be the Internet, an intranet, or an extranet system. The remote terminal device 300 can be, for example, a personal computer (PC), a notebook (NB), a tablet PC, a workstation, or other devices that are capable of network linking and data processing. The browser application can be, for example, Internet Explorer® from Microsoft, or Netscape Navigator® from Netscape Co. and so on. As the client-server model network communication system 200, the remote terminal device 300, and the browser application are well known in the art, further descriptions thereof are omitted herein.

The server management system 100 of the invention includes a management program module 102, an alarm unit 104, and a control unit 106.

The management program module 102 is installed inside the network server 110. Through the network communication system 200, the management program module 102 receives management information sent by the user via a remote terminal device 300, and then transmits a management command, corresponding to the management information, to a corresponding operating and/or control mechanism of the storage server 120 for execution of the management command.

In this embodiment of the invention, the management program module 102 is, for example, an application program, and is installed inside the network server 110. The operating system of the network server 110 is, for example, the WINDOWS 2000 or the LINUX operating system. In the WINDOWS 2000® or the LINUX operating system, a scheduling command is provided for the user to input pre-arranged task schedules, wherein the scheduling command allows remote control of scheduling via the network communication system 200. The management program module 102 is used to receive the scheduling information sent by the user via the network communication system 200, and to program the scheduling information to the operating system.

The scheduling command is used to power-on, power-off, re-start, or perform data backup of the storage service 120.

The alarm unit 104 serves to set actuation time of a server peripheral device according to the management command sent by the user from the management program module 102. In this embodiment, the alarm unit 104 is an alarm clock incorporated with an Input/Output controller chip and externally connected by an alarm-clock pin of the I/O controller chip. The input/output control chip is, for example, a super I/O chip. The alarm unit 104 receives the time setting command to set the alarm time according to a time setting command. Furthermore, the alarm unit 104 is built into the I/O chip of the storage server 120.

The control unit 106 controls operation of a server peripheral device in real time according to the actuation time. The I/O chip includes, in addition to the alarm unit 104 (in this embodiment, an alarm clock), an operational power supply. It is to be noted that, in this embodiment, the control unit 106 is an on-control pin of the I/O control chip, and is electrically connected to the power supply unit 108 to control the outputted power via the control unit 106. The actuation of the control unit 106 is achieved by the time setting of the alarm unit 104. That is, when the time set in the alarm unit 104 is up, the control unit 106 drives the power supply unit 108 to power on to start operation of the storage server 120.

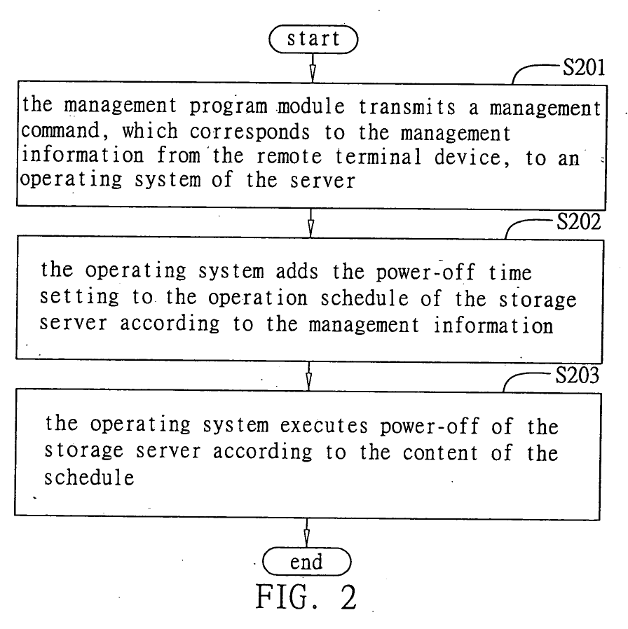

Referring to FIG. 2, the time setting for power-off of the server management via the server management system 100 is performed as set forth below.

At step S201, the management program module 102 transmits a management command, which corresponds to the management information sent by the user from the remote terminal device 300 via the network communication system 200, to an operating system of the corresponding server. In this embodiment, the remote terminal device 300 is connected to the network communication system 200 which is connected to the network server 110 of the storage server 120. After the management program module 102 inside the network server 110 is installed and actuated, the user has to input a power-off time setting to the storage server 120 via the remote terminal device 300. The power-off time setting is then transmitted to the network server 110 which directs it to the storage server 120, both of which comprise the server management system 100. Step S202 is then executed.

At step S202, the operating system of the storage server 120 adds the power-off time setting to the operational schedule of the storage server 120 according to the management information. A management command with the power-off time then stores the power-off time setting into the operational schedule of the storage server 120 via the management program module 102. Then, step S203 is executed.

At step S203, the operating system of the storage server 120 executes power-off of the storage server 120 according to the content of the schedule.

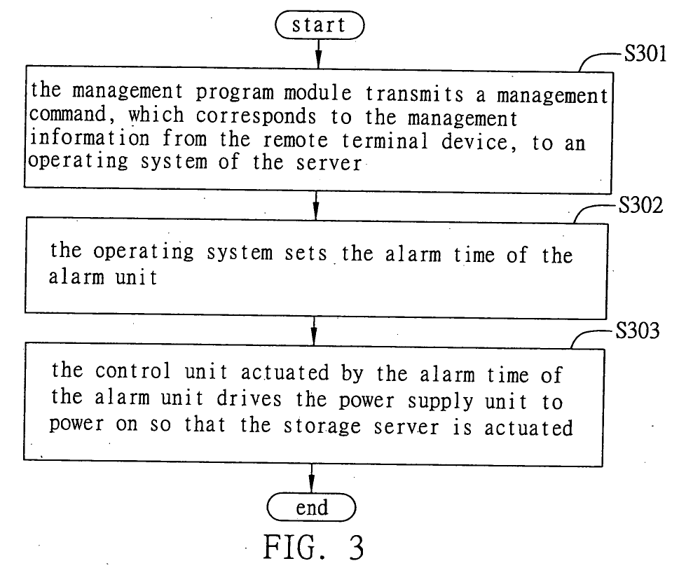

Referring to FIG. 3, controlling the power-on of the storage server via the server management system 100 is performed as set forth below.

At step S301, the management program module 102 transmits a management command, which corresponds to the management information sent from a remote terminal device 300 via the network communication system 200, to an operating system of the corresponding server. In this embodiment, the remote terminal device 300 is connected to the network communication system 200 which is connected to the network server 110 which is connected to the storage server 120. After the management program module 102 inside the network server 110 is installed and actuated, the user has to input a power-on time setting to the storage server 120 via the remote terminal device 300. The power-on time setting is transmitted to the storage server 120 via the network server 110. Step S302 is executed.

At step S302, the operating system of the storage server 120 sets the alarm time to actuate the alarm unit 104 according to the management command.

At step S303, the control unit 106 actuated by the alarm time setting of the alarm unit 104 drives the power supply unit 108 to power-on in order to actuate the storage server 120.

As described above, the server management method and system according to the invention provides a server scheduling mechanism via a remote terminal device to improve the efficiency of conventional server management.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A server management method for allowing a user to remotely manage a server via a remote terminal device and through a network communication system, the method comprising the steps of:
transmitting via a management program module a management command, which corresponds to management information sent by the user from the remote terminal device and through the network communication system, to one of an operating system and an alarm unit of the server;
adding via one of the operating system and the alarm unit a server control command to an operational schedule thereof according to the management command; and
having one of the operating system and the alarm unit drive a control unit to control the server according to the operational schedule.

2. The server management method of claim 1, wherein the management program module is mounted in a network server.

3. The server management method of claim 2, wherein the server is selected from the group consisting of an e-mail (electronic mail) server, an application program server, a file server, and a storage server.

4. The server management method of claim 1, wherein the alarm unit is provided with an I/O (Input/Output) controller chip and externally connected by an alarm-clock pin of the I/O controller chip.

5. The server management method of claim 1, wherein the server control command is written in the form of software in either the operating system or the alarm unit via the management program module.

6. The server management method of claim 1, wherein the control unit is located at an on-control position of an I/O controller chip, and is electrically connected to a power supply unit, allowing a power-on operation of the power supply unit to be controlled by the control unit.

7. A server management system for allowing a user to remotely manage a server via a remote terminal device and through a network communication system, the system comprising:
a management program module mounted in the server, to receive management information sent by the user from the remote terminal device and through the network communication system, and to transmit a management command corresponding to the management information to an operating and/or control mechanism of the server where the management command is executed;
an alarm unit for setting actuation time of a peripheral device of the server according to the management command; and
a control unit for controlling in real time actuation of the peripheral device of the server according to the actuation time.

8. The server management system of claim 7, wherein the management program module is mounted in a network server.

9. The server management system of claim 8, wherein the server is selected from the group consisting of an e-mail server, an application program server, a file server, and a storage server.

10. The server management system of claim 7, wherein the alarm unit is provided with an I/O controller chip and externally connected by an alarm-clock pin of the I/O controller chip.

11. The server management system of claim 7, wherein the control unit is located at an on-control position of an I/O controller chip, and is electrically connected to a power supply unit, allowing a power-on operation of the power supply unit to be controlled by the control unit.
